(19) United States
(12) Patent Application Publication
(10) Pub. No.: US 2008/0040335 A1
(43) Pub. Date: Feb. 14, 2008

(54) Multi-tenant CIM namespace association discovery and proxy association creation

(76) Inventors: John Gatti, Leander, TX (US); Javier L. Jiminez, Austin, TX (US)

Correspondence Address: HAMILTON & TERRILE, LLP, P.O. BOX 203518, AUSTIN, TX, 78720, US

(21) Appl. No.: 11/463,741

(22) Filed: Aug. 10, 2006

(51) Int. Cl. G06F 17/30

(52) U.S. Cl. 707/4

(57) ABSTRACT

A system and method is disclosed for providing Common Information Model (CIM) clients access to classes and metadata that do not reside in the same CIM namespace by creating shadow association classes in each namespace referenced by associated classes. Classes in a predetermined namespace are enumerated by a CIM Object Manager (CIMOM) to identify association class instances, which are likewise enumerated and searched for reference properties pointing to other namespaces. Instances referencing other namespaces are added to a class list for the referenced namespace, along with its ancestors if the association class is derived. The namespace class lists are then traversed and association class instances in each list are written to an external Managed Object Format (MOF) file. These association class instances are referenced as a shadow association class and are served by a shadow provider. Requests made to the CIMOM for a shadow association trigger the registered shadow provider, which submits a request to the base association class provider, which then returns the requested results.

### BACKGROUND OF THE INVENTION

1. Field of the Invention

The present invention relates in general to the field of information handling systems and more specifically, to systems management.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems continue to grow in power, capabilities and variety, and with the advent of the Internet, they have also become more numerous and more distributed. As a result, their management has become increasingly complex, in part due to the growing heterogeneity of the elements that comprise them and the diversity of their associated management environments. In response, the Distributed Management Task Force (DMTF) has developed frameworks that facilitate the interoperable exchange of management information between managed elements and corresponding management systems. One of these frameworks is the Common Information Model (CIM), which provides a consistent definition and structure of management information through the use of object-oriented techniques. As a conceptual information model, the CIM is structured such that managed environments can be viewed as collections of interrelated systems, each of which is comprised of a number of discrete elements.

The CIM, comprised of a specification and a schema, allows management-related information about these elements to be transparently exchanged between management systems. The specification describes an object-oriented meta model based on the Unified Modeling Language (UML) and defines how the CIM can be integrated with other management models. These include, but are not limited to, Simple Network Management Protocol (SNMP) Management Information Base (MIB) or DMTF Management Information Format (MIF). The CIM schema provides a set of classes with properties, methods and associations that define how managed elements in an environment are represented as a common set of objects. In the CIM model, managed objects such as processors, sensors and fans are presented as CIM classes, with the relationships between these managed objects presented through association classes. This hierarchical, object-oriented architecture facilitates the tracking and depiction of the often complex interdependencies and associations between managed objects.

The CIM schema also allows for definitions of namespaces, a directory-like structure that allows for the organization of classes in a more hierarchical structure. Data providers, which communicate with managed objects to access data and event notifications, are assigned to serve classes within a namespace. While these providers may access other classes or metadata in other namespaces through associations, clients are restricted to association queries within a single namespace. This restriction becomes problematic when clients query association classes that reference other namespaces. An association class defines a relationship between two classes (e.g., a computer system to the cooling fans on that system). The association can be enumerated so that all relationships of an instance of a class to instances of its related class can be viewed. Use of the association class also allows the traversal of the relationship from the related class instance through the association class to all associated classes (e.g., from specific cooling fan to associated computer system). With clients limited to intra-namespace association class queries, traversing cross-namespace associations remains an interoperability issue. Likewise, implementation of CIM profiles remains an issue when an inter-namespace association crosses vendor or profile supplier boundaries. In view of the foregoing, a system and method is needed to allow client access to classes and metadata that reside in more than one CIM namespace.

### SUMMARY OF THE INVENTION

In accordance with the present invention, a system and method is disclosed for providing Common Information Model (CIM) clients access to classes and metadata that do not reside in the same CIM namespace by creating shadow association classes in each namespace referenced by associated classes. In different embodiments of the invention, an association class is defined to the CIM Object Manager (CIMOM) with references to two associated classes. Each association class instance maps an instance of a first referenced class to an instance of a second referenced class. When the association class is enumerated, the instance provider registered for the association class is triggered. The triggered provider contains the knowledge to build a list of association instances. There may be one or more association class instances containing predetermined associated classes that exist outside the association class namespace.

In an embodiment of the invention, the resulting list of association classes is searchable to find instances for predetermined, associated classes. For example, a request could be made to get all instances of a second referenced class associated with a predetermined first refererenced class. When associated instances are requested, the CIMOM searches its class definition database for any association classes that contain a first referenced class, a second referenced class, or both, dependent upon the terms of the search query. For each association class found, an enumeration of the class is performed. Within the enumeration, any instance that contains the first or second referenced class that matches the requested instance is identified. A get procedure is performed on that instance and added to the list of associated instances.

In current CIM implementations, associations that contain references to more than one namespace must exist in each of the namespaces they reference. In these implementations, the CIMOM can recognize and process the association in each namespace. In an embodiment of the invention, a multi-tenant CIM namespace proxy association system is implemented to create shadow association classes in each namespace referenced by association classes. In this embodiment of the invention, a CIMOM connects to a predetermined namespace and enumerates all classes, and their derived classes, to identify association classes. Identified association classes are likewise enumerated and searched for reference properties pointing to other namespaces. Each instance of an association class that references another namespace is then added to a class list for the referenced namespace, along with its ancestors if the association class is derived. The resulting namespace class lists are then traversed and association class instances in each list are written to an external Managed Object Format (MOF) file, along with the predetermined namespace itself. Class qualifiers are then determined from class definitions and likewise written to the MOF output file, along with the class definitions themselves, their related properties, and property qualifiers. The MOF output file is then compiled by the CIMOM, thereby allowing the new class definitions to be known by the CIMOM, resulting in cross-namespace association traversal being optional.

In an embodiment of the invention, shadow association classes are served by a special data provider, called a shadow provider. A separate class definition file is created to support the shadow associations, which mirrors the original class definition but identifies a shadow provider to service the shadow associations. When defining association classes in this file, any association class that spans namespaces is identified and added to the shadow class definition file. At the same time, a mapping file is created that maps the shadow namespace/class to the actual, or base, namespace/class. When a request is made to the CIMOM for a shadow association, the CIMOM triggers the registered shadow provider, which then initializes if it has not already done so. Initialization consists of reading the class map file and building an internal map of the shadow association and the base association. The shadow provider finds the requested shadow association in the map and then establishes a connection to the namespace of the base association class and makes the request (e.g., enumerate or get) of the base association class provider. As part of the request, the response handler for the original CIMOM request is used to trigger the base association class provider, which then performs its processing and returns the results to the asynchronous handler. Those of skill in the art will understand that many such embodiments and variations of the invention are possible, including but not limited to those described hereinabove, which are by no means all inclusive.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a generalized illustration of an information handling system that can be used to implement the method and apparatus of the present invention;

FIG. 2 is a generalized block diagram of a Common Information Model (CIM) namespace spanning system as implemented in accordance with an embodiment of the invention,

FIG. 3 is a generalized flow chart of a CIM namespace spanning system as implemented in accordance with an embodiment of the invention, and;

FIG. 4 is a generalized flow chart of a multi-tenant CIM namespace proxy association system as implemented in accordance with an embodiment of the invention.

### DETAILED DESCRIPTION

A system and method is disclosed for providing Common Information Model (CIM) clients access to classes and metadata that do not reside in the same CIM namespace. In different embodiments of the invention, an association class is defined to the CIM Object Manager (CIMOM) with references to two associated classes. Each association instance maps an instance of a first referenced class to an instance of a second referenced class. These association class instances are referenced as a shadow association class and are served by a shadow provider. A separate class definition file is created to support the shadow associations, which mirrors the original class definition but identifies a shadow provider to service the shadow associations. Association classes that span namespaces are identified and added to the shadow class definition file, and a mapping file is created at the same time which maps the shadow namespace/class to the actual, or base, namespace/class. Requests made to the CIMOM for a shadow association triggers the registered shadow provider, which finds the requested shadow association in the map and submits a request to the base association class provider, which then returns the requested results.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

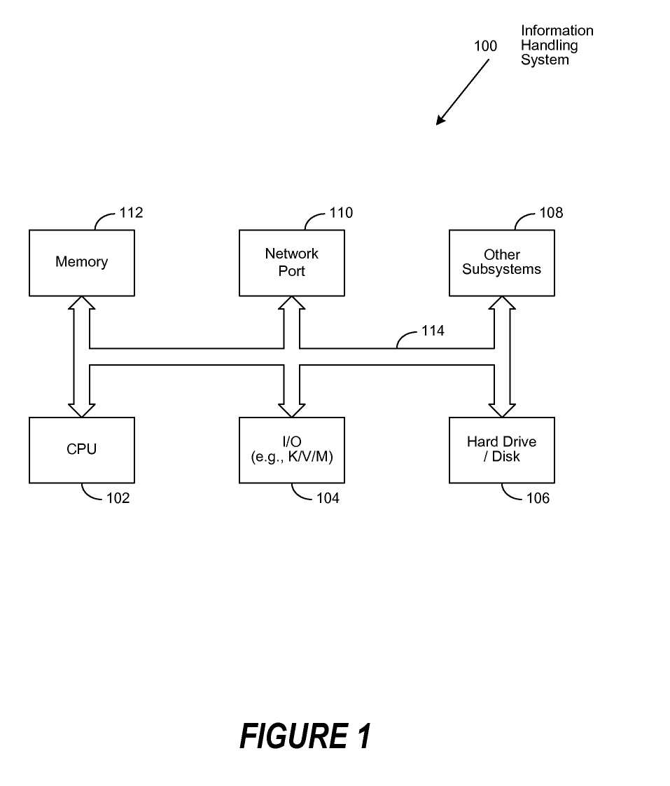

FIG. 1 is a generalized illustration of an information handling system 100 that can be used to implement the system and method of the present invention. The information handling system includes a processor (e.g., central processor unit or “CPU”) 102, input/output (I/O) devices 104, such as a display, a keyboard, a mouse, and associated controllers, a hard drive or disk storage 106, various other subsystems 108, network port 110, and system memory 112, all interconnected via one or more buses 114.

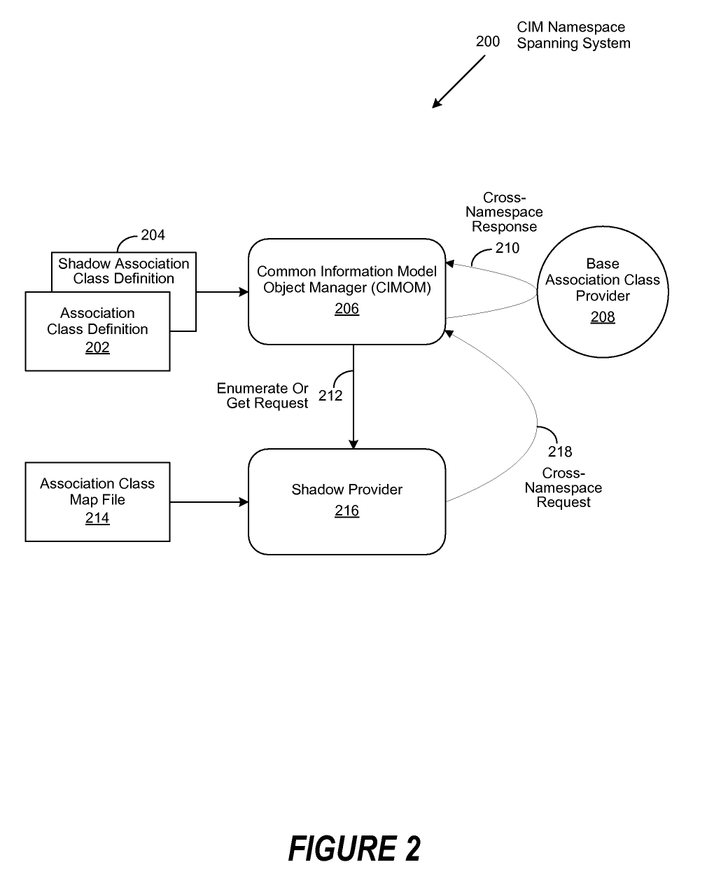

FIG. 2 is a generalized block diagram of a Common Information Model (CIM) namespace spanning system 200 as implemented in accordance with an embodiment of the invention. CIM object manager (CIMOM) 206 is a component in a CIM server that handles interactions between management applications and data providers. As such, the CIMOM supports services such as event notification, remote access, and query processing.

In different embodiments of the invention, an association class comprising a first referenced class and a second referenced classis defined to CIMOM 206. Each association instance maps an instance of a class described by the first referenced class to an instance of a second referenced class. When the shadow association class 202 is enumerated, the instance provider registered for the association class 208 is triggered. The triggered provider contains the knowledge to build a list of association instances. There may be one or more association class instances containing predetermined associated classes that exist outside the association class namespace.

In an embodiment of the invention, the resulting list of association classes is searchable to find associated instances for predetermined, associated classes. For example, a request could be made to get all instances of a second referenced class associated with a predetermined first refererenced class. When associated instances are requested, the CIMOM searches its class definition database for any association classes that contain a first referenced class, a second referenced class, or both, dependent upon the terms of the search query. For each association class found, an enumeration of the class is performed. Within the enumeration, any instance that contains the first or second referenced class that matches the requested instance is identified. A get procedure is performed on that instance and added to the list of associated instances.

In current CIM implementations, associations that contain references to more than one namespace must exist in each of the namespaces they reference. In these implementations, the CIMOM can recognize and process the association in each namespace. In an embodiment of the invention, this duplicate association class is referenced as a shadow association class definition 204 and is served by a special data provider, called a shadow provider 216. A separate association class definition file 202 is created to support the shadow associations. This class definition mirrors the original class definition but identifies shadow provider 216 to service the shadow associations. When defining association classes in this file, any association class that spans namespaces is identified and added to the shadow association class definition file 204. At the same time, a mapping file 214 is created that maps the shadow association namespace/class definition 204 to the actual, or base, namespace/class 208.

When a request is made to the CIMOM 206 for a shadow association, the CIMOM 206 triggers 212 the registered shadow provider 216, which then initializes if it has not already done so. Initialization consists of reading the class map file 214 and building an internal map of the shadow association class association 204 and the base association 208. The shadow provider 216 finds the requested shadow association in the map file 214 and then establishes a connection to the namespace of the base association class 208 and makes the request (e.g., enumerate or get) of the base association class 208. As part of the request, the response handler for the original CIMOM request is used to trigger the base association class provider 208, which then performs its processing and returns the results 210 to the asynchronous handler.

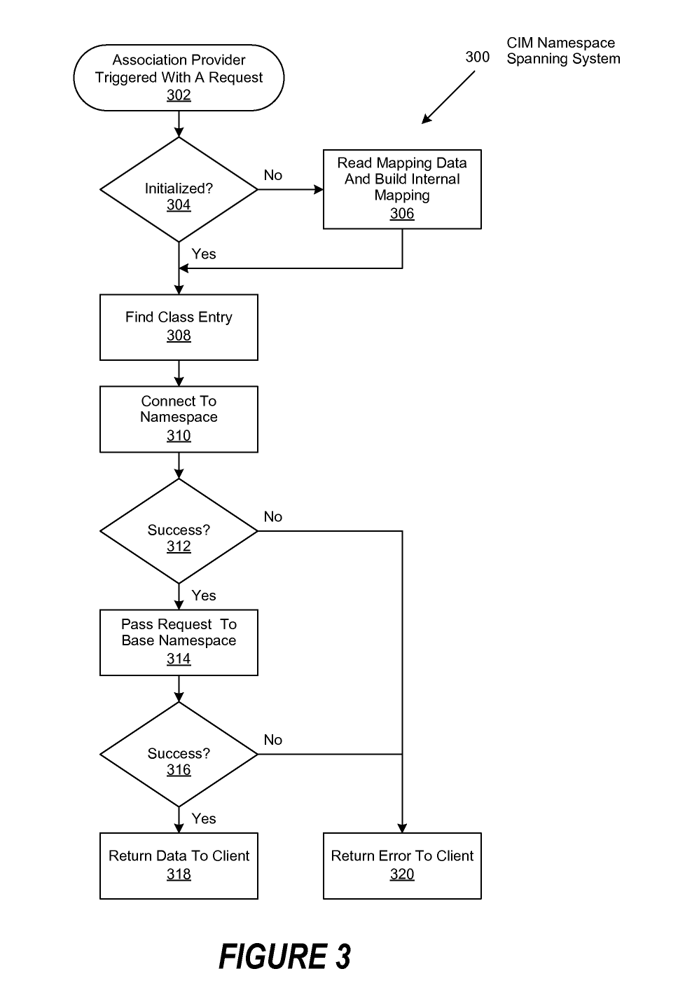

FIG. 3 is a generalized flow chart of a CIM namespace spanning system 300 as implemented in accordance with an embodiment of the invention. In Step 302 an association class provider is triggered with a request from a CIM object manager (CIMOM), and it is then determined in Step 304 whether the association class provider is initialized. If it is determined in Step 304 is not initialized, the class map file described in greater detail hereinabove is read and an internal map of shadow associations and base associations is built in Step 306. If it is determined in Step 304 that the association provider is already initialized, or once the class map is built in Step 306, then the requested shadow association class entry is found in the association class map file in Step 308.

Once the shadow association class entry is found in Step 308, a connection is established to namespace of the base association class. If the connection to the namespace of the base association is not successful, then an error message is returned to the client in Step 320. Otherwise a request (e.g., enumerate or get) is made of the base association class provider in Step 314. If no results are returned in Step 316, then an error message is returned to the client in Step 320. Otherwise, the results are returned to the client in Step 318.

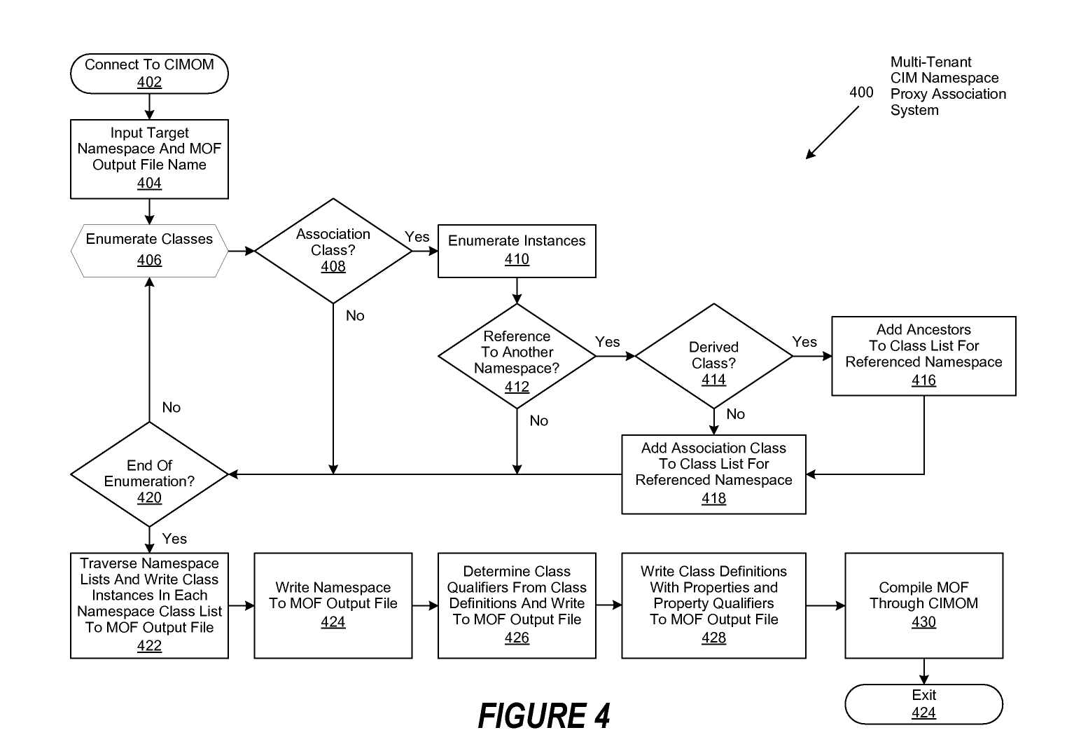

FIG. 4 is a generalized flow chart of a multi-tenant CIM namespace proxy association system 400 as implemented in accordance with an embodiment of the invention. Processing begins in step 402 by connecting to a CIMOM and submitting a predetermined namespace and a filename that specifies the output location of resultant Managed Object Format (MOF) information in step 404. In step 406, classes are enumerated in the namespace submitted in step 404, and as they are enumerated it is determined in step 408 whether they are an association class. If it is determined in step 408 that the enumerated class is not an association class, then it is determined in step 420 whether all classes in the namespace have been enumerated. If it is then determined in step 420 that not all classes in the predetermined namespace have been enumerated, then processing continues beginning with step 406. If it is determined in step 408 that the enumerated class is an association class, then instances of the association class are enumerated, and searched for reference properties pointing to other namespaces, in step 410.

If it is determined in step 412 that the enumerated instance of the association class does not reference another namespace, then it is determined in step 420 whether all classes in the namespace have been enumerated. If it is then determined in step 420 that not all classes in the predetermined namespace have been enumerated, then processing continues beginning with step 406. If it is determined in step 412 that the enumerated instance of the association class references another namespace, then it is determined in step 414 whether the enumerated instance of the association class is derived. If it is determined in step 414 that the enumerated instance of the association class is not derived, then it is added to a class list for the referenced namespace in step 418. If it is then determined in step 420 that not all classes in the predetermined namespace have been enumerated, then processing continues beginning with step 406. If it is determined in step 414 that the enumerated instance of the association class is derived, then its ancestors are added, with the exception of duplicate names, to a class list for the referenced namespace in step 416. The enumerated instance of the association class is then added to a class list for the referenced namespace in step 418. If it is then determined in step 420 that not all classes in the predetermined namespace have been enumerated, then processing continues beginning with step 406.

If it is determined in step 420 that all classes in the predetermined namespace have been enumerated, then the namespace lists are traversed and class association instances in each namespace class list are written in step 422 to the MOF output file specified in step 404. The predetermined namespace is then written to the MOF output file in step 424, and in turn, class qualifiers are determined from class definitions and written to the MOF output file in step 426. Class definitions, with their related properties and property qualifiers, are then written to the MOF output file in step 428. It will be apparent to those of skill in the art that since the enumerated association classes are the only concrete classes, they are therefore the only classes specified by the shadow provider described in greater detail hereinabove. The MOF output file is then compiled by the CIMOM in step 430, thereby allowing the new class definitions to be known by the CIMOM, resulting in cross-namespace association traversal being optional. Once the MOF output file is compiled, the CIM namespace proxy association system is exited in step 432. Skilled practitioners in the art will recognize that many other embodiments and variations of the present invention are possible. In addition, each of the referenced components in this embodiment of the invention may be comprised of a plurality of components, each interacting with the other in a distributed environment. Furthermore, other embodiments of the invention may expand on the referenced embodiment to extend the scale and reach of the system's implementation.

What is claimed is:

1. An information handling system, comprising:
a plurality of managed elements;
a common information model object manager (CIMOM) operable to:
define association classes to associate predetermined individual managed elements in said plurality of managed elements, said association classes corresponding to a first namespace; and
generate shadow association classes to associate predetermined individual managed elements in said plurality of managed elements, said shadow association classes corresponding to a second namespace;
wherein said shadow association classes are generated by said CIMOM in said second namespace; and
a shadow provider operable to map relationships between said first namespace and said second namespace.

2. The information handling system of claim 1, wherein said shadow association classes comprise references to two associated classes residing in different namespaces.

3. The information handling system of claim 2, wherein said shadow association classes comprise an external Managed Object Format (MOF) file.

4. The information handling system of claim 3, wherein said MOF file is operable to be compiled by said CIMOM.

5. The information handling system of claim 4, wherein said compiled MOF file is operable to eliminate the need for cross-namespace association traversal by providing said shadow associations to said CIMOM.

6. The information handling system of claim 2, wherein said shadow association classes are implemented using a shadow association class definition file in said second namespace and wherein said shadow association class definition file mirrors the corresponding class definition file in said first namespace.

7. The information handling system of claim 3, wherein said shadow association classes instances in said second namespace are enumerated in said shadow association class definition file.

8. The information handling system of claim 4, wherein said shadow association class definition in said second namespace mirrors a corresponding association class definition in said first namespace.

9. The information handling system of claim 5, wherein said shadow provider is identified to service said shadow association classes in said second namespace.

10. The information handling system of claim 6, wherein said shadow provider is operable to access an association class map file to generate an internal map file for mapping base association classes between said first namespace and shadow association classes of said second namespace.

11. A method for managing a plurality of elements in an information handling system, comprising:
using a common information model object manager (CIMOM) operable to:
define association classes to associate predetermined individual managed elements in said plurality of managed elements, said association classes corresponding to a first namespace; and
generate shadow association classes to associate predetermined individual managed elements in said plurality of managed elements, said shadow association classes corresponding to a second namespace, wherein said shadow association classes are generated by said CIMOM in said second namespace;
and
using a shadow provider to map relationships between said first namespace and said second namespace.

12. The method of claim 11, wherein said shadow association classes comprise references to two associated classes residing in different namespaces.

13. The method of claim 12, wherein said shadow association classes comprise an external Managed Object Format (MOF) file.

14. The method of claim 13, wherein said MOF file is operable to be compiled by said CIMOM.

15. The method of claim 14, wherein said compiled MOF file is operable to eliminate the need for cross-namespace association traversal by providing said shadow associations to said CIMOM.

16. The method of claim 12, wherein said shadow association classes are implemented using a shadow association class definition file in said second namespace and wherein said shadow association class definition file mirrors the corresponding class definition file in said first namespace.

17. The method of claim 13, wherein said shadow association classes instances in said second namespace are enumerated in said shadow association class definition file.

18. The method of claim 14, wherein said shadow association class definition in said second namespace mirrors a corresponding association class definition in said first namespace.

19. The method of claim 15, wherein said shadow provider is identified to service said shadow association classes in said second namespace.

20. The method of claim 16, wherein said shadow provider is operable to access an association class map file to generate an internal map file for mapping base association classes between said first namespace and shadow association classes of said second namespace.
